(19) United States
(12) Patent Application Publication
(10) Pub. No.: US 2025/0015624 A1
(43) Pub. Date: Jan. 9, 2025

(54) METHOD AND SYSTEM FOR MANAGING ENERGY STORAGE SYSTEM, AND NON-TRANSITORY COMPUTER-READABLE RECORDING MEDIUM

(71) Applicant: DOTS ENERGY KOREA INC., Gimpo-si Gyeonggi-do (KR)

(72) Inventor: Yong Chul KIM, Seoul (KR)

(73) Assignee: DOTS ENERGY KOREA INC., Gimpo-si Gyeonggi-do (KR)

(21) Appl. No.: 18/895,630

(22) Filed: Sep. 25, 2024

Related U.S. Application Data
(63) Continuation of application No. PCT/KR2023/004045, filed on Mar. 27, 2023.

(30) Foreign Application Priority Data
Mar. 25, 2022 (KR) 10-2022-0037501

(51) Int. Cl. H02J 7/00; H02J 3/32

(52) U.S. Cl. CPC H02J 7/007182; H02J 3/32; H02J 7/0048; H02J 7/007194

(57) ABSTRACT

A method for managing an energy storage system is provided. The method includes the steps of: determining an output control interval of a battery included in the energy storage system with reference to properties of the battery; determining a first preset output at a time point when the output control interval starts, and a second preset output at a time point when the output control interval ends; and operating the battery with reference to a derating output formed on the basis of the first preset output and the second preset output.

### CROSS-REFERENCE TO RELATED APPLICATION(S)

This application is a continuation of Patent Cooperation Treaty (PCT) International Application No. PCT/KR2023/004045 filed on Mar. 27, 2023, which claims priority to Korean Patent Application No. 10-2022-0037501 filed on Mar. 25, 2022. The entire contents of PCT International Application No. PCT/KR2023/004045 and Korean Patent Application No. 10-2022-0037501 are hereby incorporated by reference.

### FIELD OF THE INVENTION

The present invention relates to a method, system, and non-transitory computer-readable recording medium for managing an energy storage system.

### BACKGROUND

An energy storage system (ESS) is a device that stores generated electric power in a battery and then supplies the stored power when it is needed, and is primarily used to increase energy use efficiency.

However, according to global technology trends, energy storage systems are being actively utilized for a variety of electric power industries, in addition to being utilized for increasing energy use efficiency. For example, energy storage systems are recently being used for frequency regulation or system stabilization.

In order to utilize an energy storage system in various electric power industries according to the global technology trends, it is particularly important to design an energy management system (EMS) responsible for operating the energy storage system so that it can respond to the diversification of uses and purposes of the energy storage system.

In this connection, the inventor(s) present a technique for advancing the control logic of an energy management system so that the energy management system can respond to the diversification of uses and purposes of an energy storage system.

### SUMMARY OF THE INVENTION

One object of the present invention is to solve all the above-described problems in the prior art.

Another object of the invention is to enable a battery to be actively controlled according to uses and purposes of an energy storage system by operating the battery with reference to a derating output in an output control interval.

Yet another object of the invention is to ensure that an energy storage system is not placed in an inoperable state by causing operation of a battery to stop for a predetermined period of time in response to a voltage of the battery coinciding with a voltage for limiting charge and discharge of the battery.

Still another object of the invention is to secure operational reliability of an energy storage system by operating a battery using a reserve signal in response to a signal outputted from an external device being disconnected.

The representative configurations of the invention to achieve the above objects are described below.

According to one aspect of the invention, there is provided a method for managing an energy storage system, the method comprising the steps of: determining an output control interval of a battery included in the energy storage system with reference to properties of the battery; determining a first preset output at a time point when the output control interval starts, and a second preset output at a time point when the output control interval ends; and operating the battery with reference to a derating output formed on the basis of the first preset output and the second preset output.

According to another aspect of the invention, there is provided a system for managing an energy storage system, the system comprising: an interval determination unit configured to determine an output control interval of a battery included in the energy storage system with reference to properties of the battery; a preset output determination unit configured to determine a first preset output at a time point when the output control interval starts, and a second preset output at a time point when the output control interval ends; and a battery operation management unit configured to operate the battery with reference to a derating output formed on the basis of the first preset output and the second preset output.

In addition, there are further provided other methods and systems to implement the invention, as well as non-transitory computer-readable recording media having stored thereon computer programs for executing the methods.

According to the invention, it is possible to enable a battery to be actively controlled according to uses and purposes of an energy storage system by operating the battery with reference to a derating output in an output control interval.

According to the invention, it is possible to ensure that an energy storage system is not placed in an inoperable state by causing operation of a battery to stop for a predetermined period of time in response to a voltage of the battery coinciding with a voltage for limiting charge and discharge of the battery.

According to the invention, it is possible to secure operational reliability of an energy storage system by operating a battery using a reserve signal in response to a signal outputted from an external device being disconnected.

### BRIEF DESCRIPTION OF THE DRAWINGS

FIG. 1 schematically shows the configuration of an energy storage system according to one embodiment of the invention.

FIG. 2 illustratively shows the internal configuration of an energy management system according to one embodiment of the invention.

FIGS. 3A and 3B illustratively show how to operate a battery with reference to a derating output in an output control interval according to one embodiment of the invention.

FIGS. 4A and 4B illustratively show how to operate a battery with reference to a derating output in an output control interval according to one embodiment of the invention.

### DETAILED DESCRIPTION OF THE PREFERRED EMBODIMENTS

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the Energy Storage System

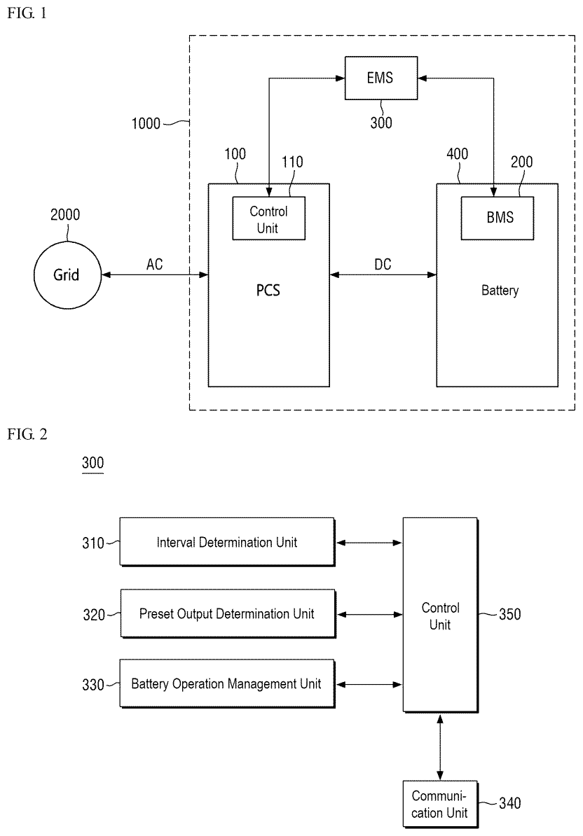

FIG. 1 schematically shows the configuration of an energy storage system 1000 according to one embodiment of the invention.

Referring to FIG. 1, the energy storage system 1000 according to one embodiment of the invention may comprise a power conditioning system (PCS) 100, a battery management system (BMS) 200, and an energy management system (EMS) 300.

First, the power conditioning system 100 according to one embodiment of the invention may function to convert DC power stored in the battery 400 to AC power and supply it to a grid 2000 (i.e., discharge the battery 400), or to convert AC power supplied from the grid 2000 to DC power and store it in the battery 400 (i.e., charge the battery 400). According to one embodiment of the invention, the functions of the power conditioning system 100 may be performed on the basis of a signal transmitted from the energy management system 300 to be described below.

Next, the battery management system 200 according to one embodiment of the invention may function to monitor the status of the battery 400 (e.g., a temperature, voltage, current, and state of charge (SOC) of the battery 400). According to one embodiment of the invention, the status of the battery 400 may be transmitted to the energy management system 300 in order to control charge and discharge outputs of the battery 400.

Lastly, the energy management system 300 according to one embodiment of the invention may function to manage (e.g., control or monitor) the energy storage system 1000 or the components included in the energy storage system 1000. For example, the energy management system 300 according to one embodiment of the invention may monitor the status of the battery 400 via the battery management system 200 and transmit a signal for controlling the charge and discharge outputs of the battery 400 to the power conditioning system 100 (or a control unit 110 of the power conditioning system 100) with reference to a result of the monitoring.

The configuration and functions of the energy management system 300 according to one embodiment of the invention will be discussed in detail below.

### Configuration of the Energy Management System

Hereinafter, the internal configuration of the energy management system 300 crucial for implementing the invention and the functions of the respective components thereof will be discussed.

FIG. 2 illustratively shows the internal configuration of the energy management system 300 according to one embodiment of the invention.

As shown in FIG. 2, the energy management system 300 according to one embodiment of the invention may comprise an interval determination unit 310, a preset output determination unit 320, a battery operation management unit 330, a communication unit 340, and a control unit 350. According to one embodiment of the invention, at least some of the interval determination unit 310, the preset output determination unit 320, the battery operation management unit 330, the communication unit 340, and the control unit 350 of the energy management system 300 may be program modules to communicate with an external system (not shown). The program modules may be included in the energy management system 300 in the form of operating systems, application program modules, or other program modules, while they may be physically stored in a variety of commonly known storage devices. Further, the program modules may also be stored in a remote storage device that may communicate with the energy management system 300. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the energy management system 300 has been described as above, and it will be apparent to those skilled in the art that at least a part of the components or functions of the energy management system 300 may be implemented in a device (not shown) or a server (not shown) or included in an external system (not shown), as necessary.

Here, the device according to one embodiment of the invention is digital equipment capable of connecting to and then communicating with the energy management system 300, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDAs), a web pad, and a mobile phone, may be adopted as the device according to the invention.

Further, according to one embodiment of the invention, the device may further include an application program for performing the functions for managing the energy storage system according to the invention. The application may reside in the device in the form of a program module. The characteristics of the program module may be generally similar to those of the interval determination unit 310, the preset output determination unit 320, the battery operation management unit 330, the communication unit 340, and the control unit 350 of the energy management system 300. Here, at least a part of the application may be replaced with a hardware device or a firmware device that may perform a substantially equal or equivalent function, as necessary.

First, the interval determination unit 310 according to one embodiment of the invention may function to determine an output control interval of the battery 400 included in the energy storage system 1000 with reference to properties of the battery 400. Here, the properties (or status) of the battery 400 according to one embodiment of the invention may include a state of charge (SOC) of the battery 400 and a temperature of the battery 400.

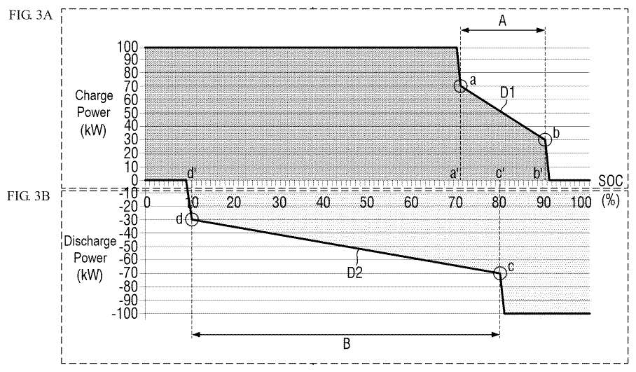

Specifically, the interval determination unit 310 according to one embodiment of the invention may determine the output control interval on the basis of the SOC of the battery 400 in order to limit a charge output of the battery 400. In this case, according to one embodiment of the invention, the SOC of the battery 400 at a time point when the output control interval starts may be lower than the SOC of the battery 400 at a time point when the output control interval ends. For example, referring to FIG. 3A, the interval determination unit 310 according to one embodiment of the invention may determine an interval in which the SOC of the battery 400 is between 70% and 90% as an output control interval A for limiting the charge output of the battery 400. That is, the interval determination unit 310 according to one embodiment of the invention may determine a time point a′ when the SOC of the battery 400 is 70% as a time point when the output control interval A starts, and determine a time point b′ when the SOC of the battery 400 is 90% as a time point when the output control interval A ends.

Further, the interval determination unit 310 according to one embodiment of the invention may determine the output control interval on the basis of the SOC of the battery 400 in order to limit a discharge output of the battery 400. In this case, according to one embodiment of the invention, the SOC of the battery 400 at a time point when the output control interval starts may be higher than the SOC of the battery 400 at a time point when the output control interval ends. For example, referring to FIG. 3B, the interval determination unit 310 according to one embodiment of the invention may determine an interval in which the SOC of the battery 400 is between 10% and 80% as an output control interval B for limiting the discharge output of the battery 400. That is, the interval determination unit 310 according to one embodiment of the invention may determine a time point c′ when the SOC of the battery 400 is 80% as a time point when the output control interval B starts, and determine a time point d′ when the SOC of the battery 400 is 10% as a time point when the output control interval B ends.

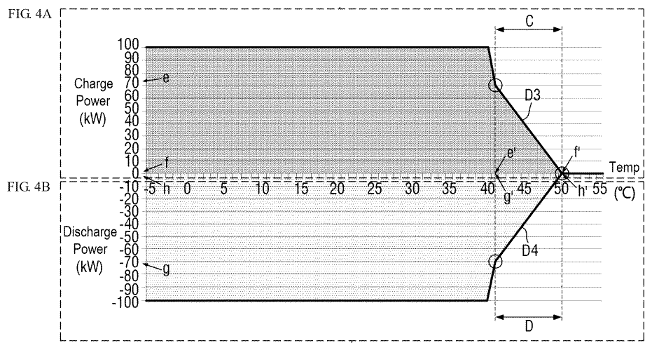

Further, the interval determination unit 310 according to one embodiment of the invention may determine the output control interval on the basis of the temperature of the battery 400 in order to limit the charge or discharge output of the battery 400. In this case, according to one embodiment of the invention, the temperature of the battery 400 at a time point when the output control interval starts may be lower than the temperature of the battery 400 at a time point when the output control interval ends. For example, referring to FIGS. 4A and 4B, the interval determination unit 310 according to one embodiment of the invention may determine an interval in which the temperature of the battery 400 is between 40° C. and 50° C. as an output control interval C for limiting the charge output of the battery 400 or an output control interval D for limiting the discharge output of the battery 400. That is, the interval determination unit 310 according to one embodiment of the invention may determine a time point (e′ in the case of limiting the charge output and g′ in the case of limiting the discharge output) when the temperature of the battery 400 is 40° C. as a time point when the output control interval C or D starts, and determine a time point (f in the case of limiting the charge output and h′ in the case of limiting the discharge output) when the temperature of the battery 400 is 50° C. as a time point when the output control interval C or D ends.

Next, the preset output determination unit 320 according to one embodiment of the invention may function to determine a first preset output at a time point when the output control interval starts, and a second preset output at a time point when the output control interval ends.

Specifically, the preset output determination unit 320 according to one embodiment of the invention may determine the first preset output and the second preset output such that the absolute value of the second preset output is less than the absolute value of the first preset output.

For example, referring to FIG. 3A, when the output control interval A for limiting the charge output of the battery 400 is determined on the basis of the SOC of the battery 400 by the interval determination unit 310 according to one embodiment of the invention, the preset output determination unit 320 according to one embodiment of the invention may determine a first preset output a at the time point a′ when the output control interval A starts as 70 KW, and determine a second preset output b at the time point b′ when the output control interval A ends as 30 kW.

As another example, referring to FIG. 3B, when the output control interval B for limiting the discharge output of the battery 400 is determined on the basis of the SOC of the battery 400 by the interval determination unit 310 according to one embodiment of the invention, the preset output determination unit 320 according to one embodiment of the invention may determine a first preset output c at the time point c′ when the output control interval B starts as −70 KW, and determine a second preset output d at the time point d′ when the output control interval B ends as −30 kW.

As another example, referring to FIG. 4A, when the output control interval C for limiting the charge output of the battery 400 is determined on the basis of the temperature of the battery 400 by the interval determination unit 310 according to one embodiment of the invention, the preset output determination unit 320 according to one embodiment of the invention may determine a first preset output e at the time point e′ when the output control interval C starts as 70 KW, and determine a second preset output f at the time point f when the output control interval C ends as 0 kW.

As another example, referring to FIG. 4B, when the output control interval D for limiting the discharge output of the battery 400 is determined on the basis of the temperature of the battery 400 by the interval determination unit 310 according to one embodiment of the invention, the preset output determination unit 320 according to one embodiment of the invention may determine a first preset output g at the time point g′ when the output control interval D starts as −70 KW, and determine a second preset output h at the time point h′ when the output control interval D ends as 0 kW.

Next, the battery operation management unit 330 according to one embodiment of the invention may function to operate the battery 400 with reference to a derating output formed on the basis of the first preset output and the second preset output.

Here, the derating output according to one embodiment of the invention may be formed on the basis of a straight line connecting the first preset output and the second preset output. In this case, according to one embodiment of the invention, the absolute value of the derating output may be linearly reduced between the time point when the output control interval starts and the time point when the output control interval ends.

For example, referring to FIG. 3A, a derating output D1 according to one embodiment of the invention may be formed as a first-order function having a slope of −(a−b)/(b′−a′) in the output control interval A.

As another example, referring to FIG. 3B, a derating output D2 according to one embodiment of the invention may be formed as a first-order function having a slope of −(|c|−|d|)/(c′−d′) in the output control interval B.

As another example, referring to FIG. 4A, a derating output D3 according to one embodiment of the invention may be formed as a first-order function having a slope of −(e−f)/(f−e′) in the output control interval C.

As another example, referring to FIG. 4B, a derating output D4 according to one embodiment of the invention may be formed as a first-order function having a slope of (|g|−|h|)/(h′−g′) in the output control interval D.

Although it has been described above that the derating output according to one embodiment of the invention is formed on the basis of a straight line connecting the first preset output and the second preset output (i.e., formed as a first-order function), the derating output according to one embodiment of the invention is not necessarily limited thereto and may be formed on the basis of a curve connecting the first preset output and the second preset output (i.e., formed as a multi-order function). In this case, according to one embodiment of the invention, the absolute value of the derating output may be nonlinearly reduced between the time point when the output control interval starts and the time point when the output control interval ends.

Meanwhile, the battery operation management unit 330 according to one embodiment of the invention may operate the battery 400 such that the output of the battery 400 in the output control interval does not exceed the derating output. Specifically, when the absolute value of the output of the battery 400 is lower than the absolute value of the derating output, the battery operation management unit 330 according to one embodiment of the invention may operate the battery with the output of the battery 400. Further, when the absolute value of the output of the battery 400 is higher than the absolute value of the derating output, the battery operation management unit 330 according to one embodiment of the invention may operate the battery 400 with the derating output.

Meanwhile, the battery operation management unit 330 according to one embodiment of the invention may determine (or set) a first voltage for limiting charge of the battery 400 and a second voltage for limiting discharge of the battery 400. Further, the battery operation management unit 330 according to one embodiment of the invention may cause the operation of the battery to stop for a predetermined period of time in response to a voltage of the battery 400 (more specifically, a voltage of cells of the battery 400) coinciding with the first voltage or the second voltage. Here, the first voltage and the second voltage according to one embodiment of the invention may be set to a value different from a voltage that is set on the basis of manufacturing characteristics of the battery 400. Specifically, according to one embodiment of the invention, the first voltage may be set to a value less than an upper limit voltage that is set on the basis of the manufacturing characteristics of the battery 400, and the second voltage may be set to a value greater than a lower limit voltage that is set on the basis of the manufacturing characteristics of the battery 400.

More specifically, according to one embodiment of the invention, when the voltage of the cells of the battery 400 falls outside a management range (i.e., a range that exceeds the lower limit voltage and falls below the upper limit voltage) that is set on the basis of the manufacturing characteristics of the battery 400 (an NCM or LFP type battery is typically used in the energy storage system 1000, wherein the NCM type battery generally has a management range of 2.8 V to 4.3 V and the LFP type battery generally has a management range of 2.5 V to 3.65 V), a relay in a battery rack may be opened to force the operation of the battery 400 to stop. That is, according to one embodiment of the invention, when the voltage of one cell falls outside the management range, the energy storage system 1000 may be placed in a fault state that disables its operation, even if the voltage of the remaining cells falls within the management range. According to one embodiment of the invention, while it is important to technically protect the battery 400 by placing the energy storage system 1000 in the fault state, it is also very important from an operational standpoint to enable the energy storage system 1000 to continue to operate by implementing the functionality for deferring the fault state. Therefore, the battery operation management unit 330 according to one embodiment of the invention may defer the fault state by setting a first voltage (set to a value less than the upper limit voltage of the management range) and a second voltage (set to a value greater than the lower limit voltage of the management range) within the management range, and causing the operation of the battery 400 to stop for a predetermined period of time in response to the voltage of the battery 400 coinciding with the first voltage or the second voltage as described above.

Meanwhile, the battery operation management unit 330 according to one embodiment of the invention may operate the battery 400 using a reserve signal for operating the battery 400, in response to a signal for operating the battery 400 outputted from an external device (not shown) being disconnected for a predetermined period of time. Here, the reserve signal according to one embodiment of the invention may be a signal generated by the battery operation management unit 330 itself. Further, the external device according to one embodiment of the invention may be a remote control device that performs higher-level control over the energy management system 300 (or the energy storage system 1000), such as a device in which the functions of a network operation center (NOC) or an operator test program (or a dispatcher) are implemented.

According to one embodiment of the invention, the external device may output a signal for operating the battery 400 and transmit it to the energy management system 300 (more specifically, the battery operation management unit 330), and the energy management system 300 may operate the battery 400 using the signal transmitted from the external device. Here, according to one embodiment of the invention, when communication between the external device and the energy management system 300 is disconnected, the energy management system 300 may continue to operate the battery 400 using the signal transmitted from the external device immediately before the communication is disconnected. However, since the above signal does not reflect the real-time status of the battery 400, continuing to operate the battery 400 using the signal may interfere with stable operation of the battery 400, causing overcharge or overdischarge of the battery 400, for example. Therefore, the battery operation management unit 330 according to one embodiment of the invention may operate the battery 400 using the reserve signal for operating the battery 400 in response to the signal for operating the battery 400 outputted from the external device being disconnected for a predetermined period of time as described above, so that the battery 400 may be stably operated.

More specifically, the battery operation management unit 330 according to one embodiment of the invention may detect that the communication with the external device is disconnected and operate the battery 400 using the reserve signal after a predetermined period of time (e.g., 1 minute) has elapsed from the time of the detection (wherein the battery operation management unit 330 according to one embodiment of the invention may cause the operation of the battery 400 to stop (i.e., cause the output of the battery 400 to be 0 kW) using the reserve signal). That is, the battery operation management unit 330 according to one embodiment of the invention may operate the battery 400 using the signal transmitted from the external device immediately before the communication is disconnected during the predetermined period of time, and operate the battery 400 using the reserve signal after the predetermined period of time has elapsed. Meanwhile, when the disconnected communication is restored while the battery 400 is operated using the reserve signal, the battery operation management unit 330 according to one embodiment of the invention may operate the battery 400 using a signal outputted from the external device in real time. Further, even when the disconnected communication is restored before the predetermined period of time elapses, the battery operation management unit 330 according to one embodiment of the invention may operate the battery 400 using a signal outputted from the external device in real time.

Next, the communication unit 340 according to one embodiment of the invention may function to enable data transmission/reception from/to the interval determination unit 310, the preset output determination unit 320, and the battery operation management unit 330.

Lastly, the control unit 350 according to one embodiment of the invention may function to control data flow among the interval determination unit 310, the preset output determination unit 320, the battery operation management unit 330, and the communication unit 340. That is, the control unit 350 according to the invention may control data flow into/out of the energy management system 300 or data flow among the respective components of the energy management system 300, such that the interval determination unit 310, the preset output determination unit 320, the battery operation management unit 330, and the communication unit 340 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for managing an energy storage system, the method comprising the steps of:
determining an output control interval of a battery included in the energy storage system with reference to properties of the battery;
determining a first preset output at a time point when the output control interval starts, and a second preset output at a time point when the output control interval ends; and
operating the battery with reference to a derating output formed on the basis of the first preset output and the second preset output.

2. The method of claim 1, wherein the properties of the battery include a state of charge (SOC) of the battery and a temperature of the battery.

3. The method of claim 1, wherein in the operating step, the battery is operated such that an output of the battery in the output control interval does not exceed the derating output.

4. The method of claim 1, wherein in the operating step, a first voltage for limiting charge of the battery and a second voltage for limiting discharge of the battery are determined, and the operation of the battery is stopped for a predetermined period of time in response to a voltage of the battery coinciding with the first voltage or the second voltage.

5. The method of claim 4, wherein the first voltage and the second voltage are different from a voltage that is set on the basis of manufacturing characteristics of the battery.

6. The method of claim 1, wherein in the operating step, the battery is operated using a reserve signal for operating the battery, in response to a signal for operating the battery outputted from an external device being disconnected for a predetermined period of time.

7. A non-transitory computer-readable recording medium having stored thereon a computer program for executing the method of claim 1.

8. A system for managing an energy storage system, the system comprising:
an interval determination unit configured to determine an output control interval of a battery included in the energy storage system with reference to properties of the battery;
a preset output determination unit configured to determine a first preset output at a time point when the output control interval starts, and a second preset output at a time point when the output control interval ends; and
a battery operation management unit configured to operate the battery with reference to a derating output formed on the basis of the first preset output and the second preset output.

9. The system of claim 8, wherein the properties of the battery include a state of charge (SOC) of the battery and a temperature of the battery.

10. The system of claim 8, wherein the battery operation management unit is configured to operate the battery such that an output of the battery in the output control interval does not exceed the derating output.

11. The system of claim 8, wherein the battery operation management unit is configured to determine a first voltage for limiting charge of the battery and a second voltage for limiting discharge of the battery, and cause the operation of the battery to stop for a predetermined period of time in response to a voltage of the battery coinciding with the first voltage or the second voltage.

12. The system of claim 11, wherein the first voltage and the second voltage are different from a voltage that is set on the basis of manufacturing characteristics of the battery.

13. The system of claim 8, wherein the battery operation management unit is configured to operate the battery using a reserve signal for operating the battery, in response to a signal for operating the battery outputted from an external device being disconnected for a predetermined period of time.
